(19) United States
(12) Patent Application Publication
(10) Pub. No.: US 2007/0282812 A1
(43) Pub. Date: Dec. 6, 2007

(54) PROCESS EXECUTION SUPPORT SYSTEM

(75) Inventor: Jerome D. Johnson, Bayfield, WI (US)

Correspondence Address: HERSHKOVITZ & ASSOCIATES, 2845 DUKE STREET, ALEXANDRIA, VA, 22314, US

(73) Assignee: SUPERIOR EDGE, INC., BAYFIELD, WI (US)

(21) Appl. No.: 11/683,949

(22) Filed: Mar. 8, 2007

Related U.S. Application Data
(60) Provisional application No. 60/780,925, filed on Mar. 8, 2006.

(51) Int. Cl. G06F 17/30

(52) U.S. Cl. 707/3

(57) ABSTRACT

A thin-client based process execution system for use on the internet is described. The process execution system organizes content in a process and defines that content for the process by a series of parameters such as role in the organization, knowledge, and how the user works.

### RELATED APPLICATION

This application claims the benefit of U.S. Provisional Application Ser. No. 60/780,925 filed Mar. 8, 2006, which is incorporated herein by reference and made a part hereof.

### FIELD OF THE INVENTION

The subject matter herein relates to computer software applications and, more particularly, to a process execution support system.

### BACKGROUND OF THE INVENTION

Enterprise resource planning (ERP) systems evolved in the latter part of the 20^{th} century to integrate and coordinate many (administrative functions may be better than business processing) business processing functions into a single enterprise-wide processing system. Initial implementations were focused on manufacturing operations, and were initially termed Manufacturing Requirements Planning (MRP) systems. As these enterprise-wide processing system expanded to encompass accounting, inventory, order processing, billing and similar business processing functions, the application category gained the ERP moniker.

Roughly in parallel, new applications were created to address the sales and marketing segments of the enterprise. Initially termed Sales Force Automation, as they evolved they incorporated additional functionality and were collectively named Customer Relationship Management (CRM). These applications are focused on creating server based, centralized data bases of customer information and reporting activities of these to sales management and corporate management. Companies such as Siebel Systems, a major supplier of CRM solutions, grew to be a large company, with high market capitalization. They generally provide database-oriented information which tries to answer the senior management questions of “What's really going on in field sales? What are the sales people doing on a day-to-day basis? Are we getting new customers? What are our margins on a product-by-product basis?” They generally concentrate attention and valuable time of the salesperson on administrative tasks such as “To Do” lists, customer lists and profiles, sales call schedules, filling out reports on the “opportunity pipeline,” forecasting, order entry, etc.

Also during this time a number of software-based interactive selling tools were developed to provide salespeople with sales tasks such as product configuration, proposal generation, presentation generation, and so on. Some of these tools were integrated with major CRM application offerings, with varying degrees of success. While these applications typically provided significant value to salespeople, many were often difficult to use. Also, they did not address the question of when and where to use them, leaving this to the salespersons discretion. As a result, many tools were both underutilized by some salespeople, and misutilized by others.

Eventually SAP, Oracle, Microsoft, and others introduced their own versions of CRM software solutions following the approach, the functionality and success of Siebel. While Siebel and others have been successful with corporate customers who have “bought the vision,” they have been less successful in getting the sales team to adopt the system. As a result, many CRM implementations are incomplete or underutilized, and the vision has yet to be fully realized.

When one takes a general view of the range of CRM products used by business enterprises today, they tend to concentrate their applications in the “Administrative” and “Coordinate & Correlate” low return-on-investment segments shown in the sales application value pyramid of FIG. 2.

Notwithstanding the obvious low value to the enterprise of this “management information” orientation, which placed an unwelcome burden of reporting and paperwork on the field salespersons, the CRM market has grown in the last 15 years to a multi-billion dollar market. A significant part of the CRM market is devoted to computer and communications equipment, installation and maintenance services, and administration of these complex systems.

Common characteristics of these CRM solutions are:
Generic in functionality or expensive to license, customize and install,
Generally not accepted and little used by the sales and marketing organizations. They view many of these CRM applications as an “unwanted overhead burden solely aimed at providing management information about their activities, which do little or nothing to assist them in making the sale. Gartner Group, the market research firm, has stated that “75% of field sales application products are perceived, by the salespersons using them, to have failed to meet expectations 12 months after deployment.”

Failed to successfully integrated the important role of indirect sales channels which, in many cases, account for the majority of revenues in the sale of an enterprise's products,
Difficult to gain organizational adoption and change behavior as to how people perform their jobs in the “new environment”,
Difficult to customize to fit the organization's needs, and
Server based, causing a dramatic increase in costs and IT department headcount.

Companies such as Salesforce.com have addressed some of the shortcomings listed above such as costs to license and time to implement and costs to maintain. However, they have not addressed the fundamental need of addressing sales effectiveness where the promised ROI and organizational adoption is achieved.

Customers are still looking for “next generation” products or solutions focused on sales process execution that includes sales tools focused on the success of sales channels. These products should be designed and developed to accommodate the unique nature of most sales channels. These products and customer-specific solutions should integrate elements of data mining, sales portals, e-commerce, e-learning, training and communications, product configuration, sales proposal, order entry, ERP, customer segmentation and interactive selling. Sophisticated analytics should be integrated to measure factors such as competency, activity, lead generation, sales call effectiveness, and actual sales versus plan. Such analytics should report sales trends and status through observation of activity without requiring manual input from the salesperson.

Customers also are looking for a solution that organizes content in a process by defining a set of parameters that can be simple such as role and more complex such as the method of performing work. These solutions may be delivered in the form of a vertical market oriented, “customer specific” solution which is easy to use and integrates elements of the customer's prior investment in CRM, ERP, and other information technology which may presently be in use by the customer. This enables the customer to benefit from proven processes, and essentially brings Six Sigma quality and process discipline in a user-friendly way to the sales activity of a business enterprise.

For example, vertical market solutions can be created for various industry segments such as sales, insurance or health care. These solutions may also be focused on the highest ROI items in the Gartner “Sales Application Value Pyramid,” which includes the launch of new products/programs, the integration of product lines following a merger or acquisition, and the introduction of products into new geographic markets.

The present invention provides a solution to these that may solve, or at least reduce, some or all of the aforementioned problems, and offers other advantages over the prior art.

### SUMMARY

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is related to a software system that solves or at least reduces some or all of the above-mentioned problems. In accordance with one embodiment of the invention, a solution is disclosed for organizing content and tools in a process and tailoring content and tools for the process by a series of parameters such as role in the organization, knowledge, and how the user works.

Additional advantages and features of the invention will be set forth in part in the description that follows, and in part, will become apparent to those skilled in the art upon examination of the following or may be learned by practice of the invention.

### BRIEF DESCRIPTION OF THE DRAWINGS

FIGS. 1 through 62 are shown and described below.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures that are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be explicitly set forth in the specification in a definitional manner that directly and unequivocally provides the special definition for the term or phrase.

After a complete reading of the present application, those skilled in the art will recognize that the operating environment for the illustrative thin-client system disclosed herein is only one example of a suitable operating environment and does not suggest any limitation as to the scope of use or functionality of the invention. Other well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

In one illustrative embodiment, the following process execution system is delivered over the internet, using a thin-client, server based approach. Such a thin-client-based system can readily be deployed to a variety of customers quickly with minimal effort and little chance of software incompatibility issues. Those of ordinary skill in the art will appreciate that thin-client based systems may include many components, but at a minimum, a sufficient number of components sufficient for practicing the present invention. It will also be appreciated by those skilled in the art that the functions described below could readily be adapted or implemented for use in other systems besides thin-client systems. For example, the system could be configured as a stand-alone application with a similar appearance or changed to reflect the needs of the user as those needs change and technology evolves. Also, the system could be implemented on a handheld device specifically configured to run the system.

A thin-client-based system typically includes one or more server systems, with network connections to one or more client systems. A server system typically consists of processing units, video display adapter, and a mass memory, all connected via a bus. The mass memory generally includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by processing devices. A client system typically consists of one or more processing units, a display adapter, mass memory, and a input device such as a pen or keyboard. Client systems may optionally include long term storage devices such as flash memory, optical and magnetic storage, etc.

The mass memory may also include another type of computer-readable media, namely computer storage media. Computer storage media may include volatile and nonvolatile, removable and non-removable media implemented in any method or technology for storage of information, such as computer readable instructions, data structures, program modules or other data. Computer storage media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The mass memory may store an operating system for controlling the operation of a thin-client based system. It will be appreciated that this operating system may be one of several known to those of ordinary skill in the art, such as UNIX, MAC OS™, LINUX™, or Microsoft WINDOWS, or special purpose operating systems designed for the operation of handheld organizer devices and cell-phones. Basic input/output system (“BIOS”) may be provided for controlling the low-level operation of processing unit and communicating with external devices, such as a touch screen, mouse, keyboard, and similar input devices.

One skilled in the art will recognize that the server for the thin-client system may be a set of processing components typically found within a back-office dedicated processing system. Of course, other processing systems including general purpose computing systems containing additional peripherals and user interface devices also may implement the programmable processing according to various embodiments of the present invention without deviating from the spirit and scope of the present invention as recited within the attached claims. For example, a dedicated processing system may consist of a digital signal processor (DSP) for performing the required floating-point math, various internal memory types including FLASH, ROM, RAM, and FPGA, some minimal external memory system, and a user interface and display driver chip to run the switches and custom LCD display.

Additionally, the embodiments described herein are implemented as logical operations performed by a programmable processing device. In one illustrative embodiment, the logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein are variously referred to as operations, steps, or modules.

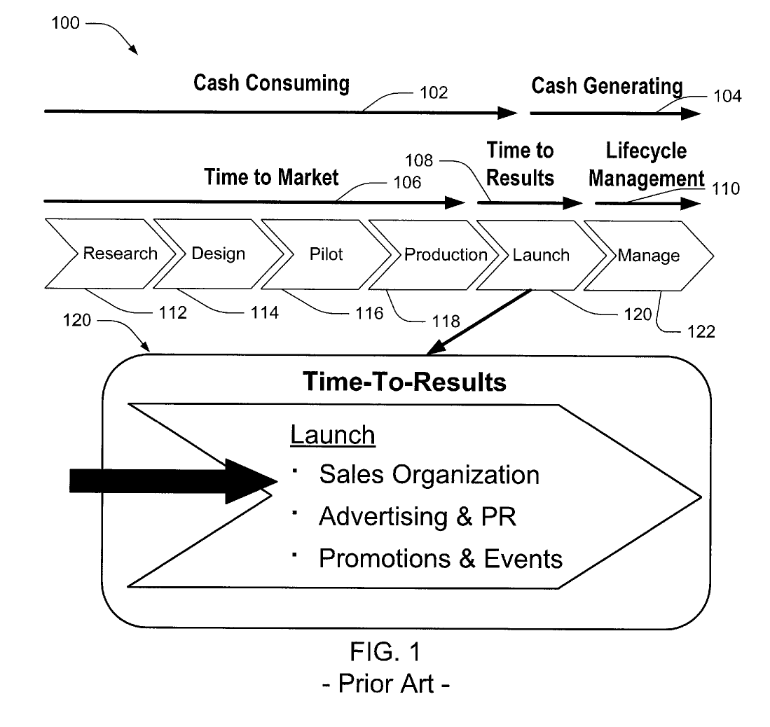

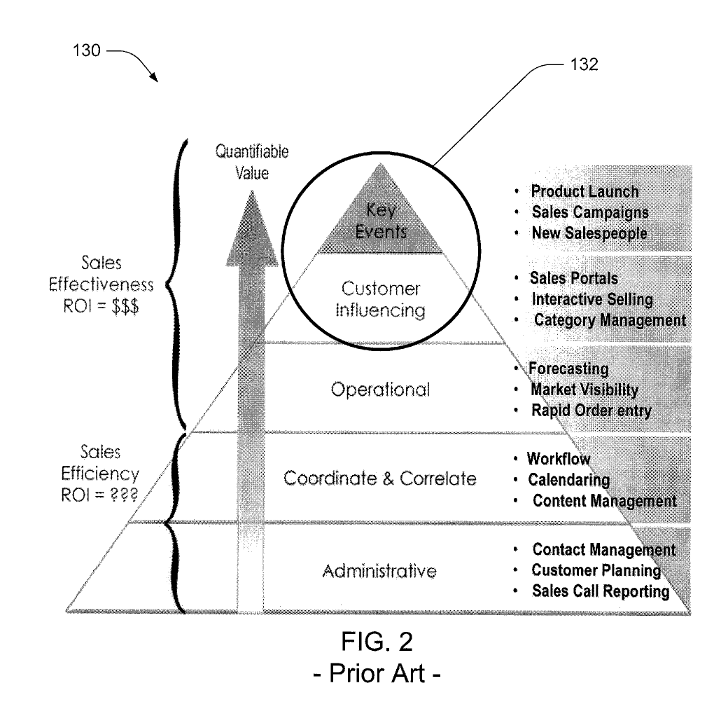

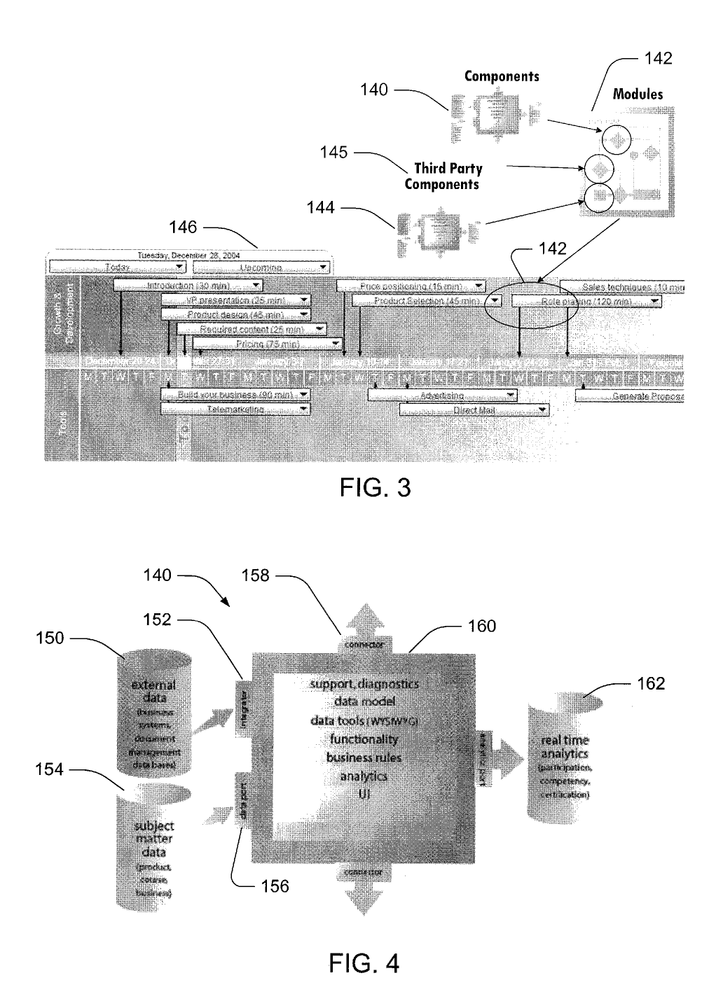

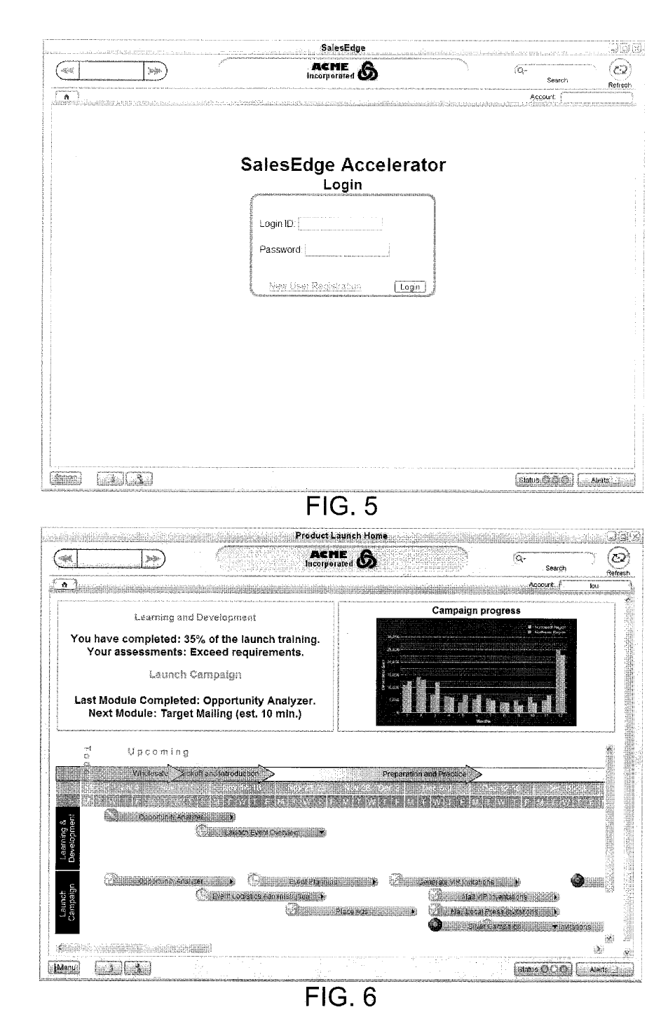

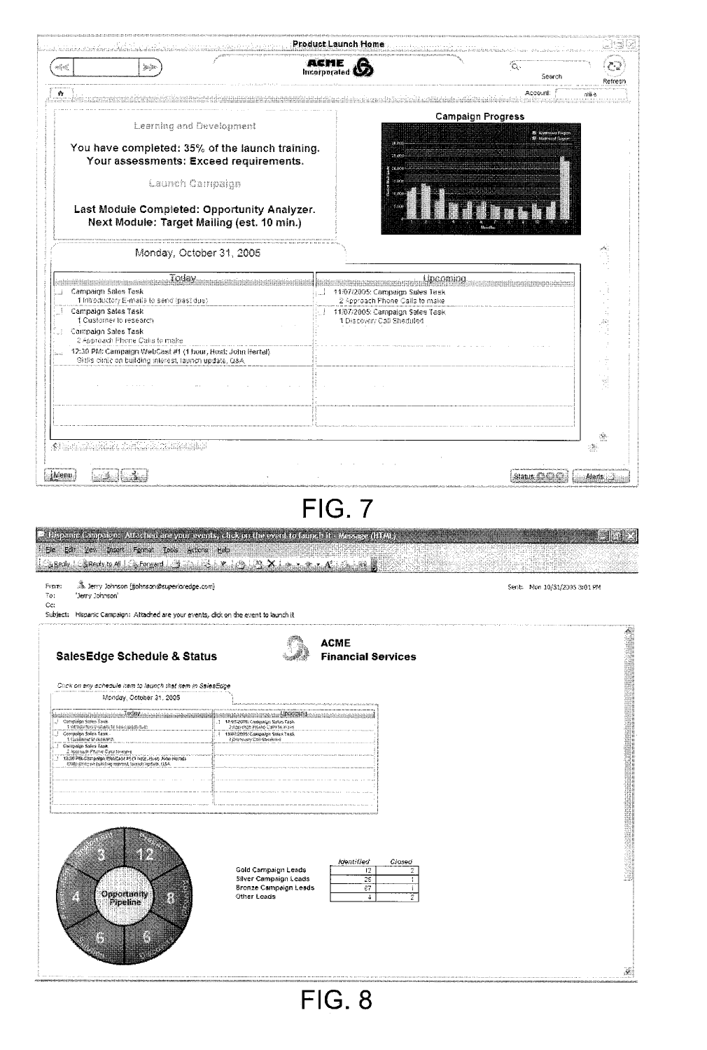

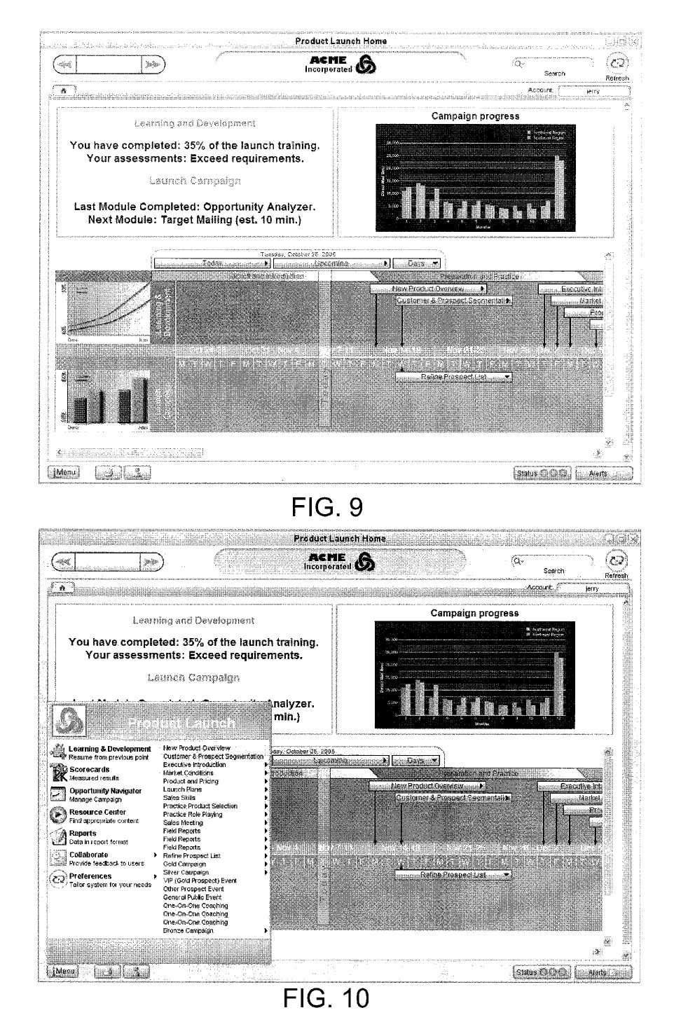

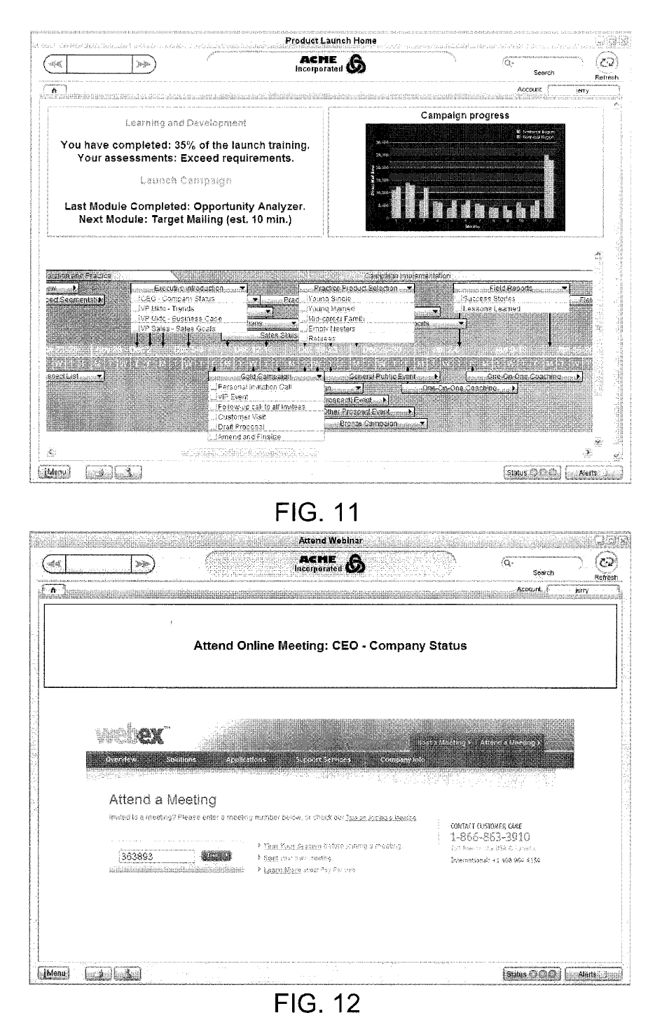

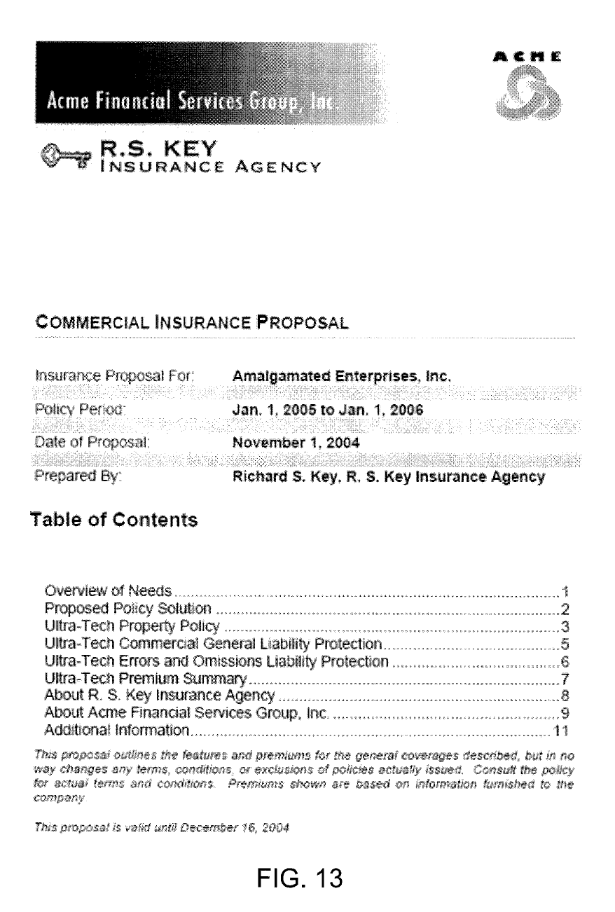

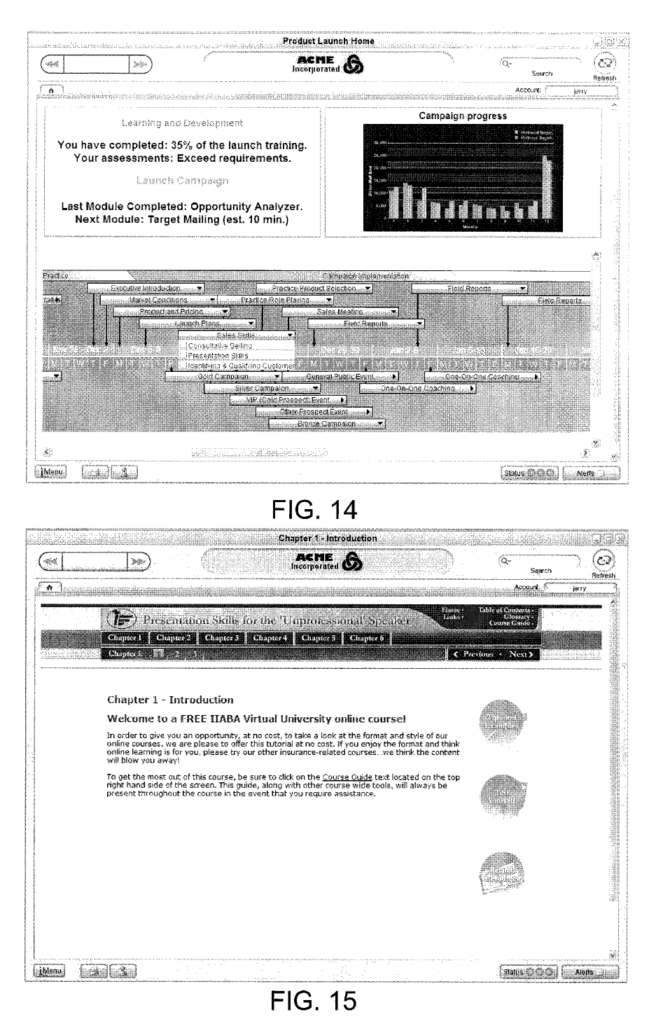

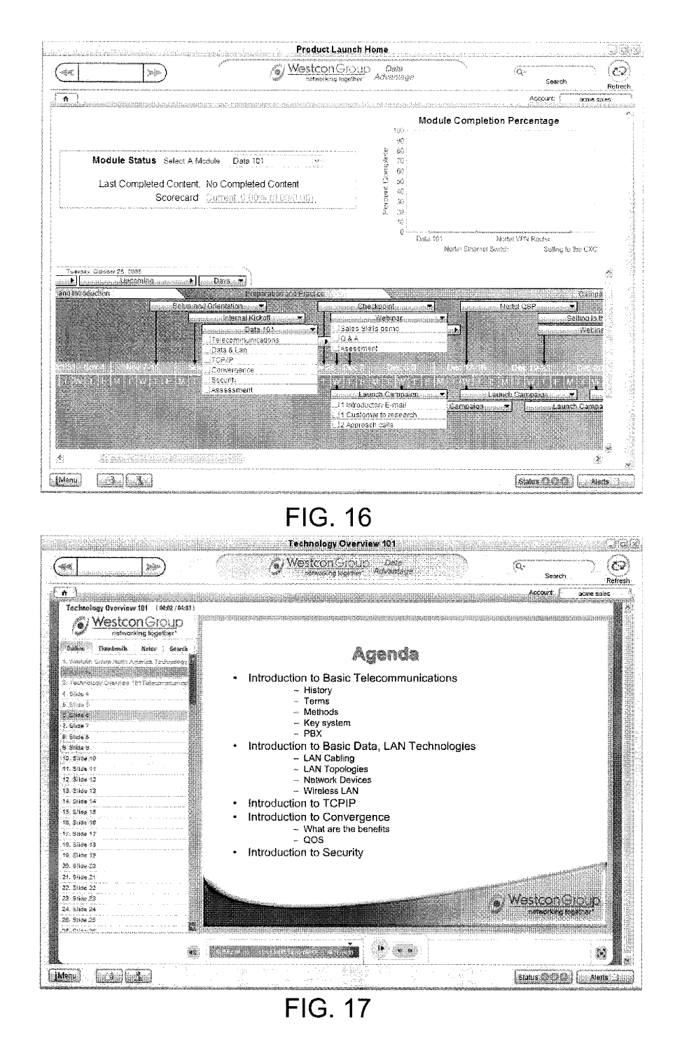

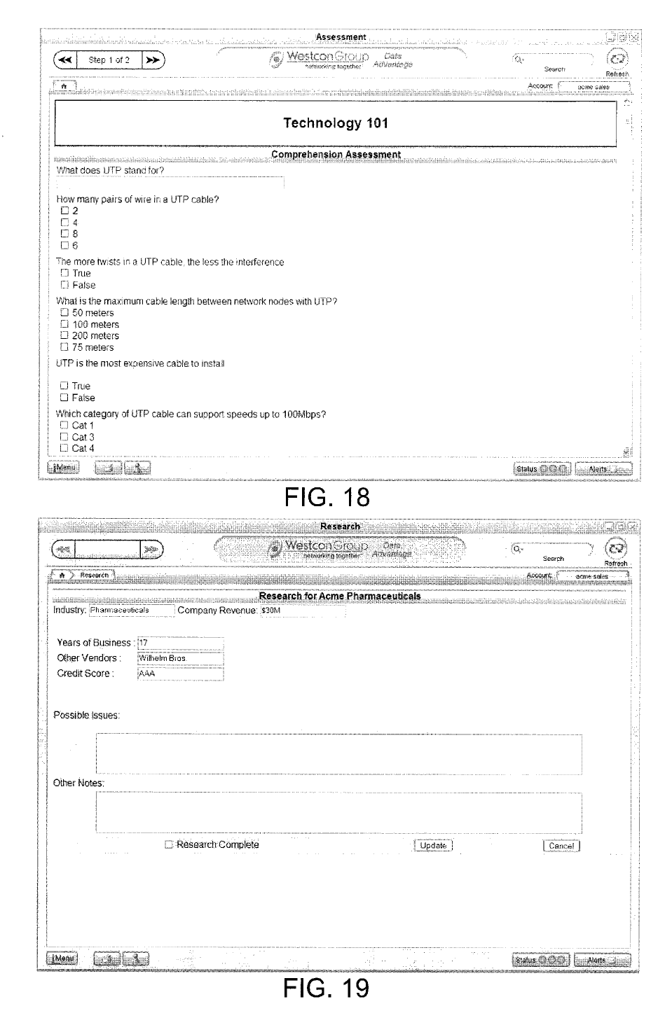

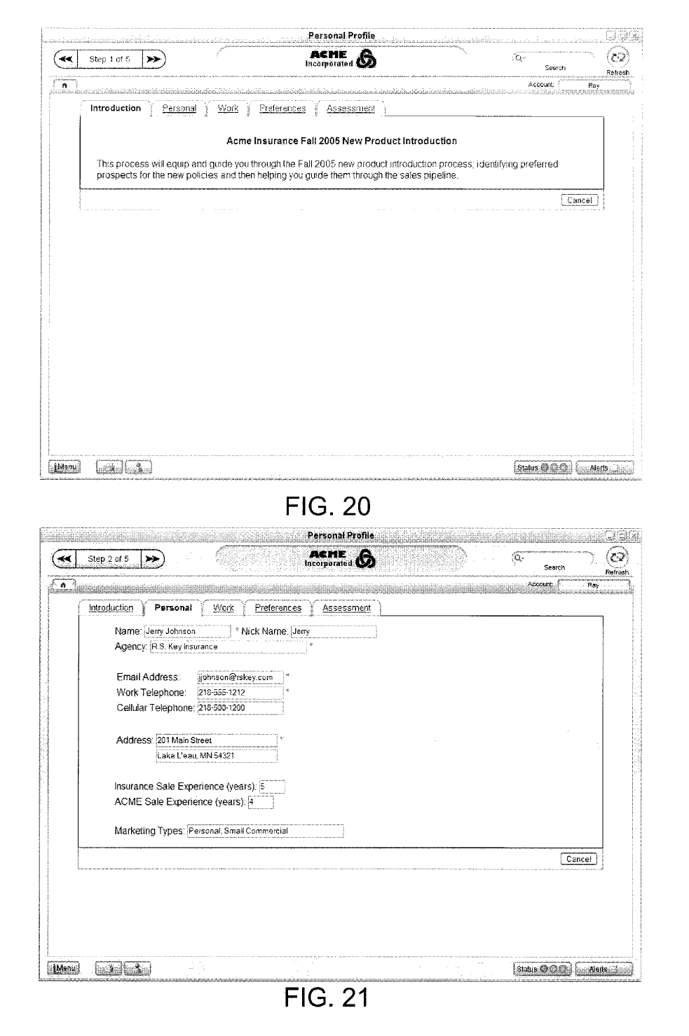

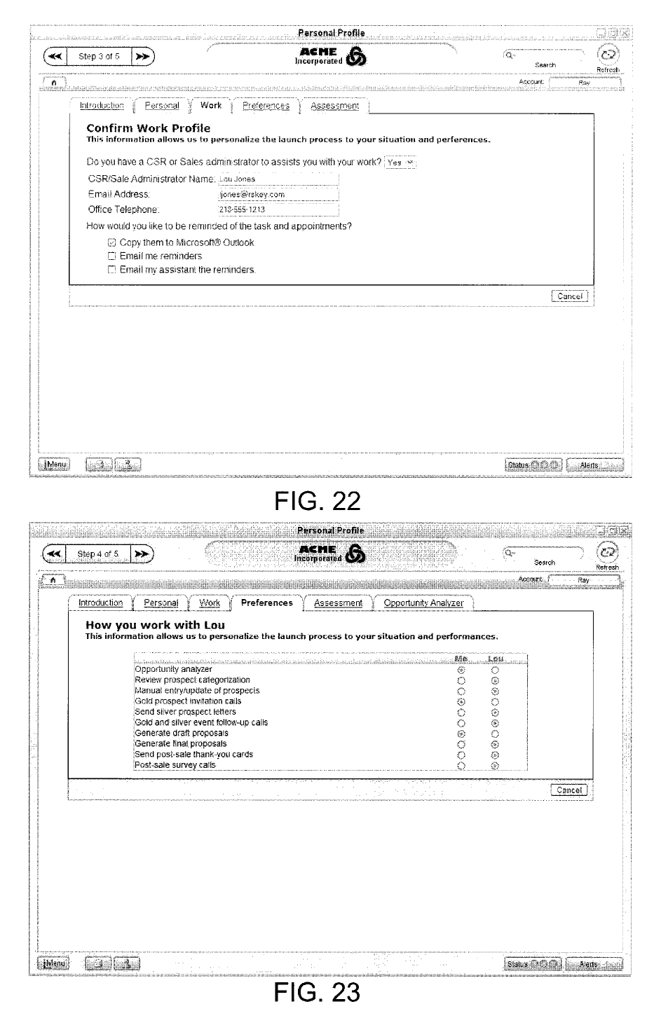

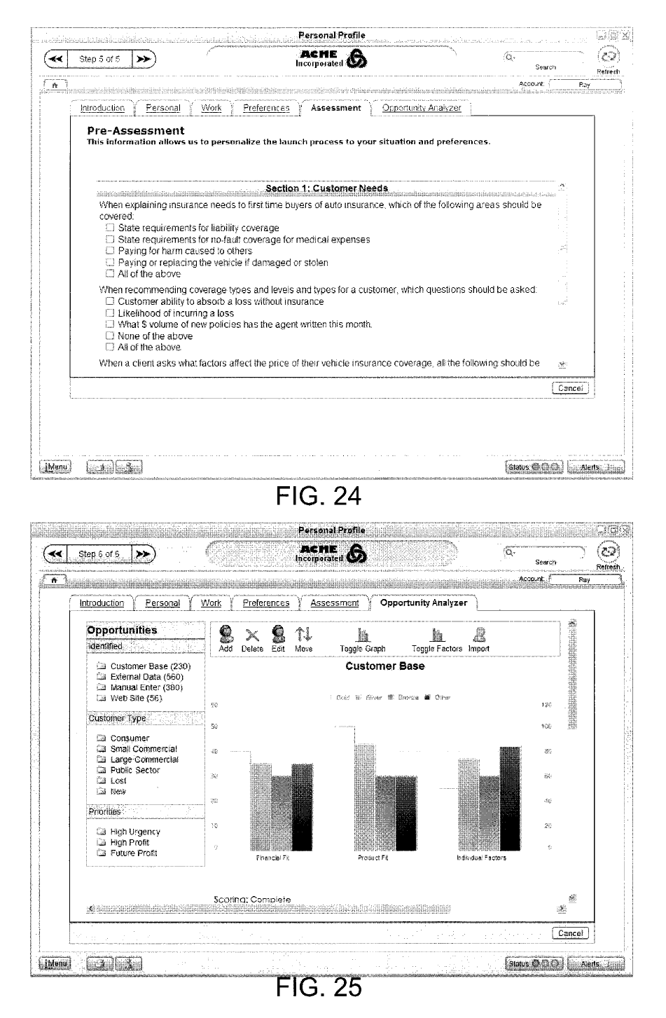

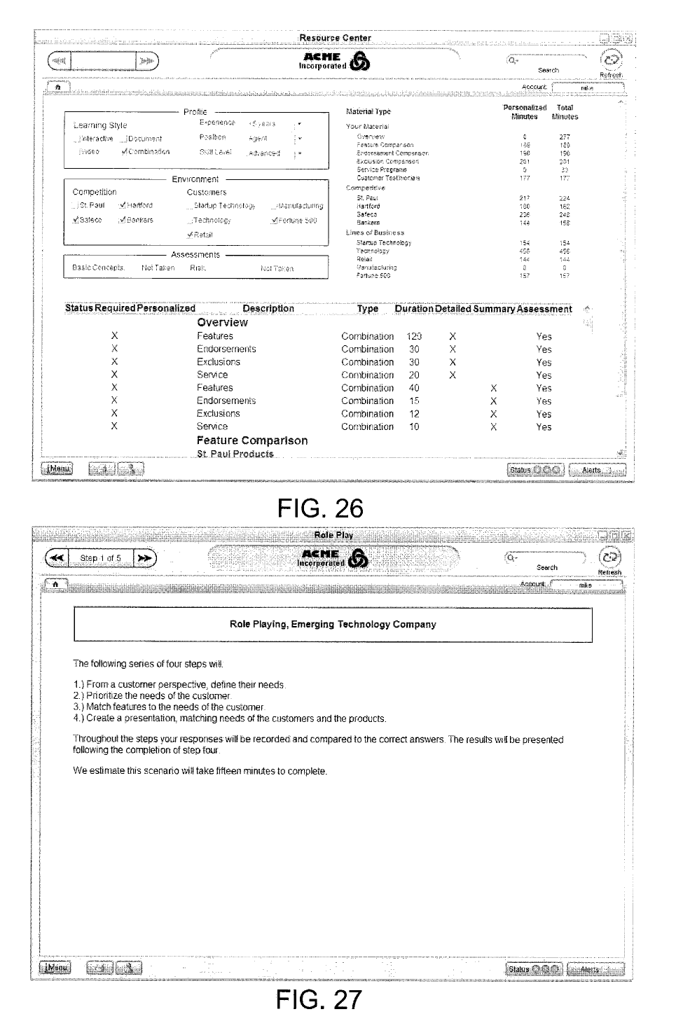

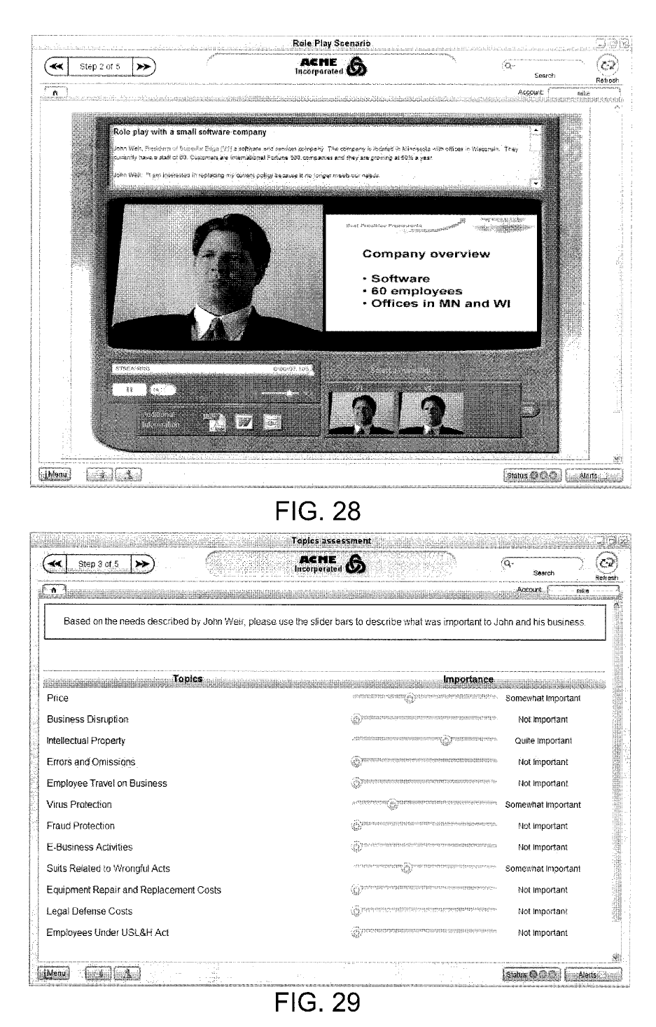

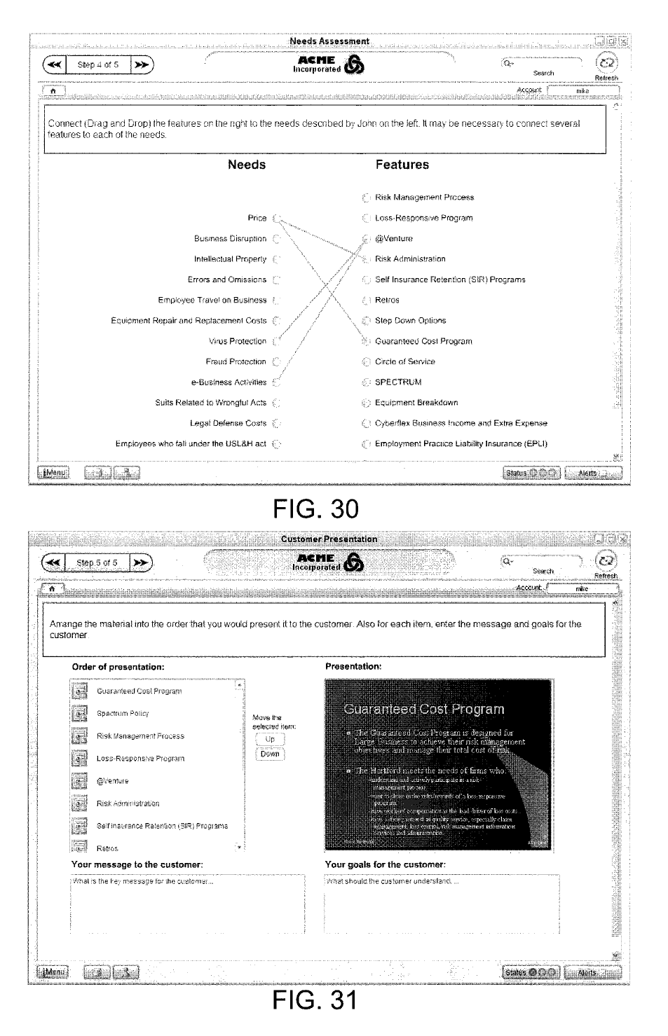

FIG. 1 shows a typical product prior art development life cycle 100. In a product development cycle, the product goes through several stages, including: research 112, design 114, pilot 116, production 118, launch 120 and manage 122. The early stages 102 are cash consuming and the later stages 104 are cash generating. Another way to describe the stages is that the early stages 106 involve time to market, the middle stages 108 involve time to results and the later stages 110 involve life cycle management. One of the most critical stages is the launch stage 120 (or time to results). It is at this stage that the sales organization, advertising, public relations, promotions and other events are typically initiated. The effectiveness of the launch 120 to the direct and indirect sales organization has an important impact on the ultimate results.

Virtually any product market would benefit from an improved launch 120 process (e.g., Insurance/Financial Services, Product Manufacturers, Pharmaceuticals, Technology and Government). To develop a more effective launch 120, a project or process solution could be created. Ideally, the development tools and environment would be reusable components plus module builder, analytics and delivery platform. These components can be organized in frameworks that can be customized for product launch, campaign launch, program launch and other launch activities. When any of these frameworks are customized for a particular industry vertical, they could be readily leveraged to multiple customers in the same vertical industry for little additional cost compared to traditional, custom-development approaches.

Shown in FIG. 2 is a typical prior art sales process pyramid 130 having five levels organized from the bottom up on tasks that must be done to ones that should be done which correlates to the higher level tasks adding more value or return on investment (ROI). Sales automation tools presently on the market focus on increasing sales efficiency, rather than sales effectiveness. Sales efficiency functions include improving administrative functions like contact management, customer planning, and sales call reporting. In addition, other sales systems improve efficiency by coordination activities such as workflow management integration with Enterprise Resource Planning (ERP) systems, calendaring and content management.

Sales effectiveness can be improved operationally with better forecasting, market visibility and rapid order entry. A need exists for sales effectiveness systems that focus on the two highest value tasks 132 of customer influencing and key launch events. The following description details such a high value sales effectiveness system. As outlined below, customer influencing can be improved with sales portals, interactive selling and category management when integrated with key launch events such as sales campaign management and salesperson training. The sales effectiveness system should also help identify and close sales opportunities.

As shown in FIGS. 3 and 4, a system preferably is designed to facilitate reuse and leverage of existing pre-designed components 140, existing client components 144, and 3rd party components 145. These components can be integrated as a module 142 in a wide variety of processes such as launching a product or campaign. These components from disparate sources can be delivered to a customer based on role and type of launch, on-demand, over the Internet, and in a preconfigured module. As such, where possible and practical, third party functionality can be licensed and existing customer investments in content and sales tools can be leveraged.

In one illustrative aspect, the present invention integrates these components together as a sales effectiveness system, frameworks can be tailored (add, modify, and delete components) at a reduced cost. The system may have the key features described in Table 1 below. Further, the framework can be populated with customer data to create the launch solution.

TABLE 1

| Key | |
|---|---|
| Features | Description |
| Process | What to do & when - to accelerate sales. |
| Based | |
| Integration | Synchronize and align everything to support the |
| | launch: campaigns, tools, training, coaching |
| Frameworks | Reduce costs and time to implement solutions. |
| Approach | |
| Role Based | Personalized launch experience based on: role in the |
| | organization, experience of the person, work style and |
| | support resources |
| Scorecard | Enable management oversight and intervention |
| Architecture | Integrated into the salespersons environment and |
| | delivered on-demand. |

Beginning at FIG. 5 and continuing through FIG. 45 are representative screen shots of how one illustrative embodiment of a sales effectiveness system would look. This sales effectiveness system delivers content such as tasks that need to be performed by particular users and identifies when they need to do those tasks. These tasks could be contacting a sales prospect, coaching another person in the organization, completing and elearning online class, preparing a presentation, or one of any other typical business tasks. The key is that these tasks are linked together for the user and others in the organization so that a product launch or other complex project can be tracked and completed. One way that this is accomplished is by use of active agents in the system that identify particular tasks that need to be done now and identify how the completion of those tasks affects other users and other tasks. Thus, time management or calendaring functions are an aspect of the present invention. This aspect and others will be described in more detail below.

FIGS. 46 through 62 show screen shots of an illustrative framework development package that may be used to configure and optimize a sales effective system for a particular customer.

Turning now to FIG. 5, a login screen is shown. A login is used to identify a particular user so that the system can be configured and presented to the user based on user preferences, role or other criteria. For example, a user may choose to view the system as a thin client based timeline (FIG. 6), daily and upcoming events (FIG. 7), thin-client or thick-client based e-mail (FIG. 8), or salesperson role view (FIG. 9). Other role views could be sales support (CSR), sales managers, channel principals, or corporate field personnel. Analytics can track and report progress success of each user and group of users or roles in using the sales effectiveness system.

FIG. 10 shows the same sales person role view as FIG. 9, however, the menu option button has been clicked so that the menu options are showing. FIG. 11 shows the same sales person role view as FIG. 9, but moved into future more, with exploded view of four modules. FIG. 12 shows the screen arrived at by clicking on CEO-Company Status in FIG. 11. FIG. 13 shows a draft proposal generated by clicking on Draft Proposal in Gold Campaign from FIG. 11. It will be appreciated by those skilled in the art that this proposal may be generated as a draft proposal for the customer (PDF document) with a third party component or pre-existing customer created proposal generation system. FIG. 14 shows the same screen or dashboard as FIG. 11 with sales skills task expanded. Clicking on Presentation Skills task launches E-learning course shown in FIG. 15.

FIG. 16 shows a reseller salesperson role dashboard with 3 modules expanded. FIG. 17 shows a screen from WestCon “Technology Overview 101” training module that is launched by clicking on Telecommunication in Data 101 on home screen in FIG. 16. In this training module, an agenda is shown with several slides from a slide show presentation. At the end of the slideshow, an assessment is shown to a user (see FIG. 18). This assessment tests whether the user actually read and understood the slideshow by asking questions that can only be answered after reviewing the slideshow. Successful completion of the assessment will indicate to the system that the user has completed this training. If the user clicks on customer to research in the dashboard shown in FIG. 16, research notes from FIG. 19 in the launch campaign task.

If a new user logs in to the login shown in FIG. 5, a series of set up screens are presented to the new user (see FIGS. 20-25). In FIG. 20, a first screen is shown for new users that gathers basic contact information about the user. FIG. 21 shows a second registration screen that facilitates editing/entry of personal contact and preference information. FIG. 22 shows a third registration screen that allows personalization of work style and situation. FIG. 23 provides for further definition of work assignments when administrative help is available. FIG. 24 shows a pre-assessment that is given to user to assess his/her current knowledge level. FIG. 25 shows the final step in registration where a user may optionally run opportunity analyzer to score and segment customers and prospects for launch campaigns that also gauge potential dollar value to salesperson for launch.

FIG. 26 shows yet another customization or profiler for a user that is specific to a particular vertical industry. In this case, a screen of insurance related filtering options for content is based on a user profile.

FIGS. 27 though 32 show an insurance role play training module for an emerging technology company. In FIG. 28 a video display portion of the role play is presented, showing a written narration option, video panel, accompanying slides, and resource documents. After watching the video, as shown in FIG. 29, a user is asked to complete a needs prioritization assessment based on the role play with a series slider bar selections. As shown in FIG. 30, another form of needs assessment from the insurance role play could be a matching of needs to features. FIG. 31 shows a customer presentation assessment from the insurance demo role play, showing a task that asks the user to re-order of slides for customer presentation based on the content of the video. FIG. 32 shows a results reporting screen from the insurance role play, showing results of each assessment including user feedback.

FIG. 33 shows a home dashboard for another vertical industry, namely a health industry vertical with the menu options shown. FIG. 34 shows an executive scorecard view format from a rural health demo that shows analytics for a program launch in healthcare management. The analytics show campaign progress, learning, and coaching progress. FIG. 35 shows expanded views of several modules. If one of the presentation tasks is clicked in the dashboard shown in FIG. 35, a screen like FIG. 36 will show a portion of the presentation module for rural health demo. As another form of campaign launch training, FIG. 37 shows a strategy game module that asks a user to connect tasks in a strategy map. FIG. 38 shows yet another module type where a portion of a mail merge tool for a customer satisfaction survey.

FIGS. 39 through 41 show campaign management summary screens. These screens show all prospects in salespersons campaign database, showing current campaign stage, and hyperlinks to customer information and/or tools for next stage. FIG. 40 shows analytics generated by the using the system and FIG. 41 shows exceptions and provides the ability to take corrective action.

FIG. 42 shows a coaching report for a manager to use in helping a user improve on various aspects of a launch by showing a comparison between the user and the overall campaign goals.

FIG. 43 is an alternative view sales dashboard where a timeline of tasks is displayed. (Note, similar data is displayed differently in FIG. 16).

FIG. 44 shows a demo dashboard for a sales rep role, showing analytics, training, and campaign steps. Contrast with campaign steps in FIG. 45 for sales manager. FIG. 45 shows a demo dashboard for a sales manager role. Note, similar training to sales role in FIG. 44, but different campaign tasks (coaching).

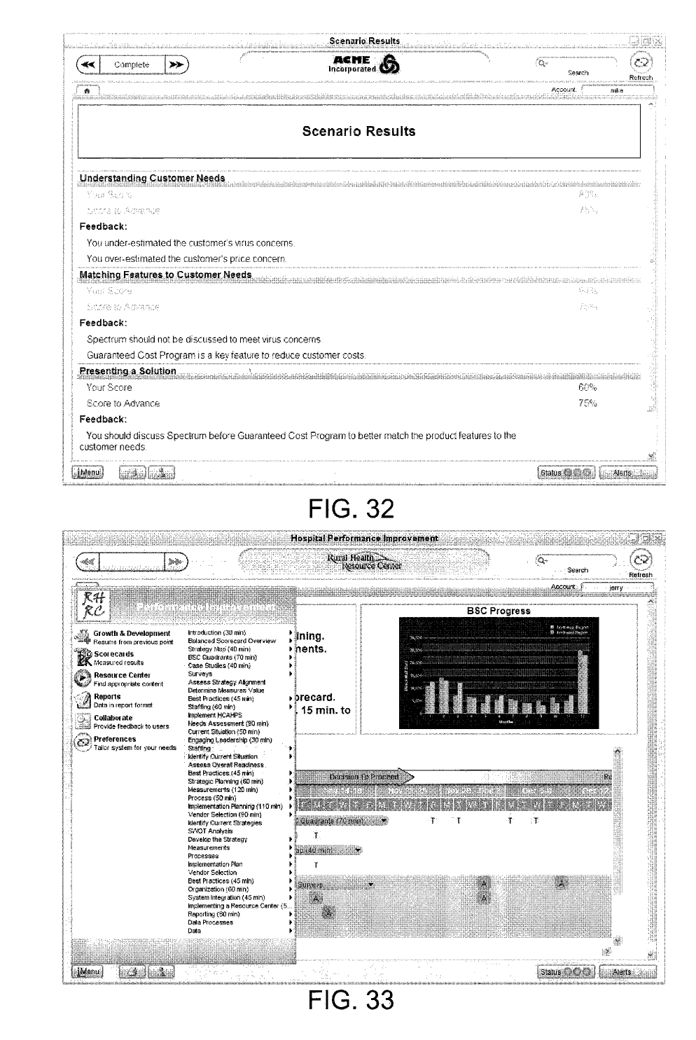

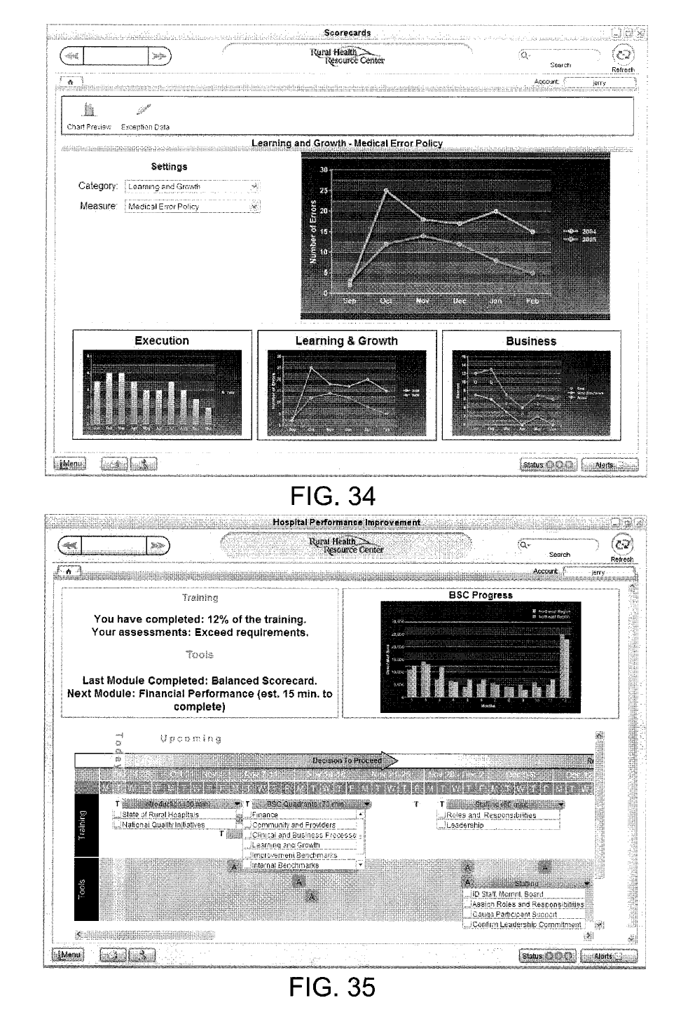

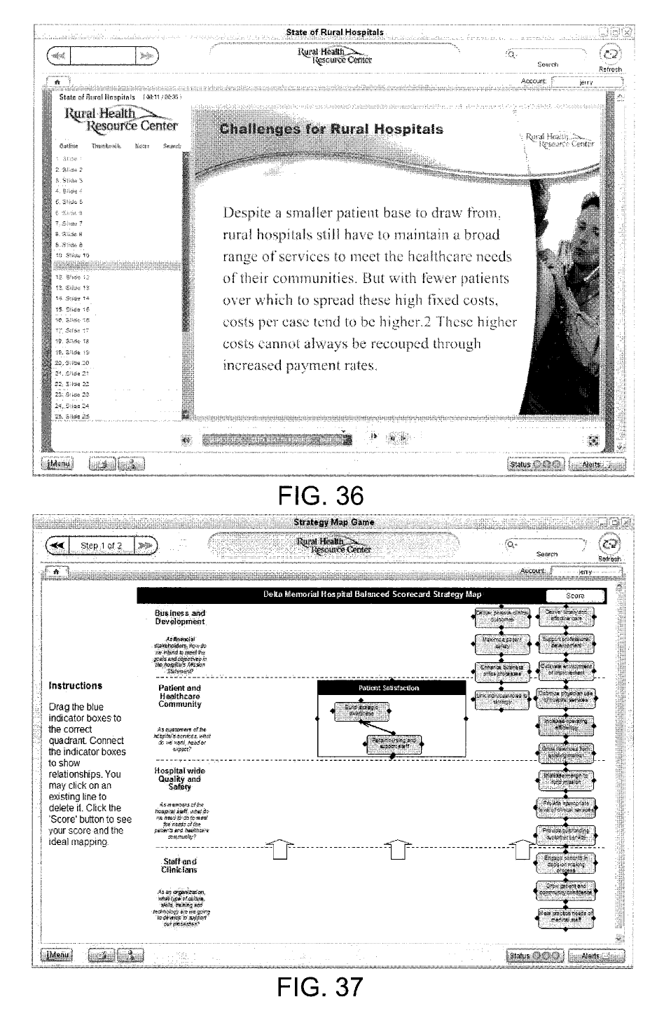

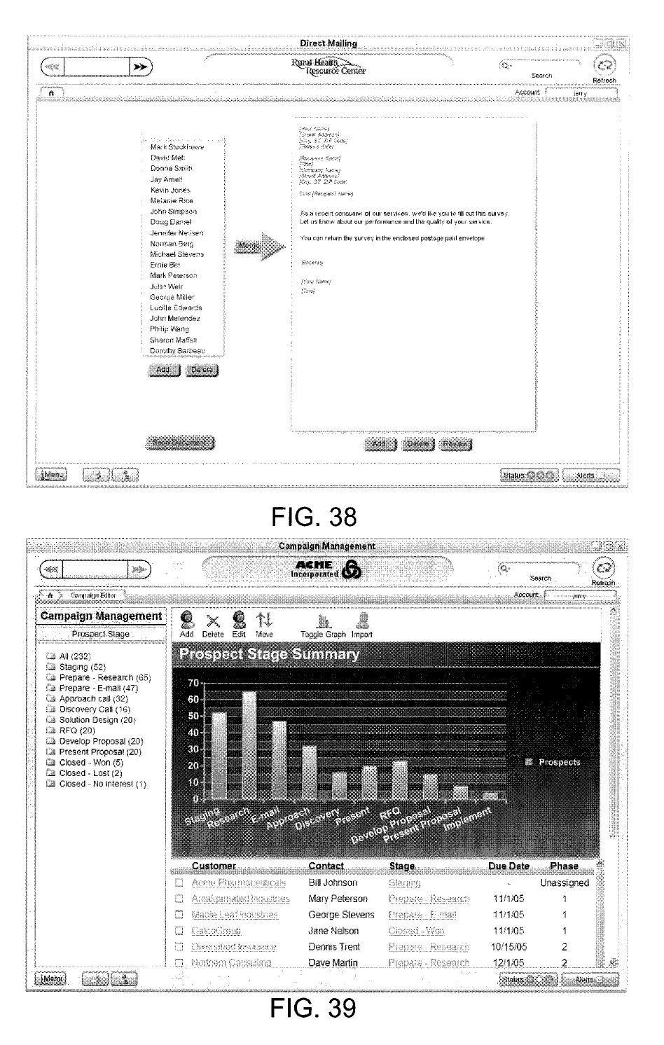

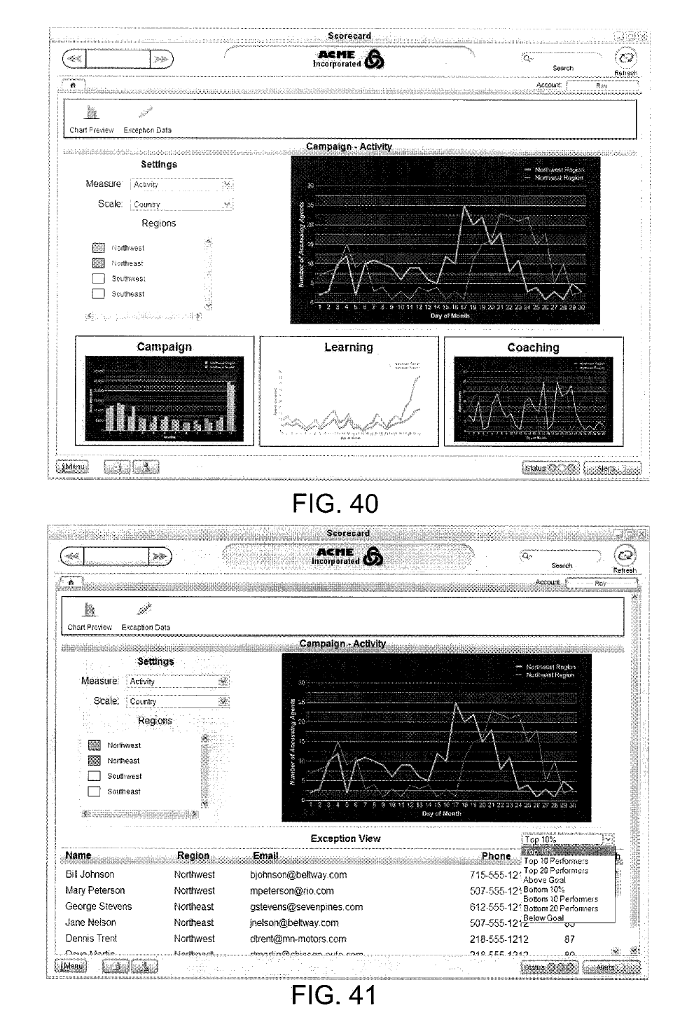

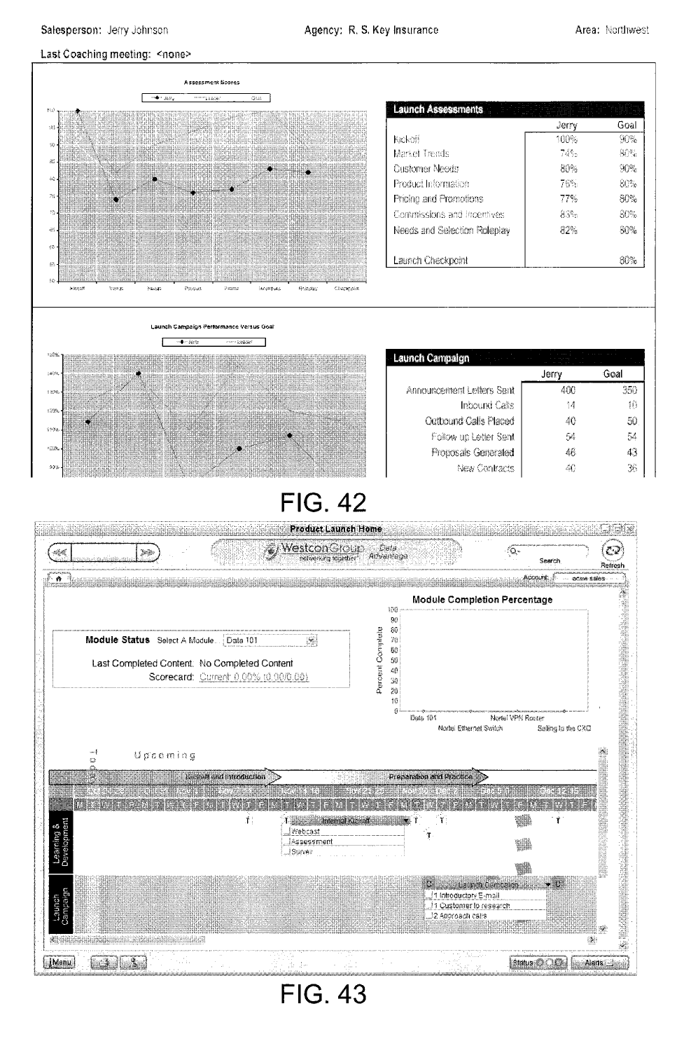

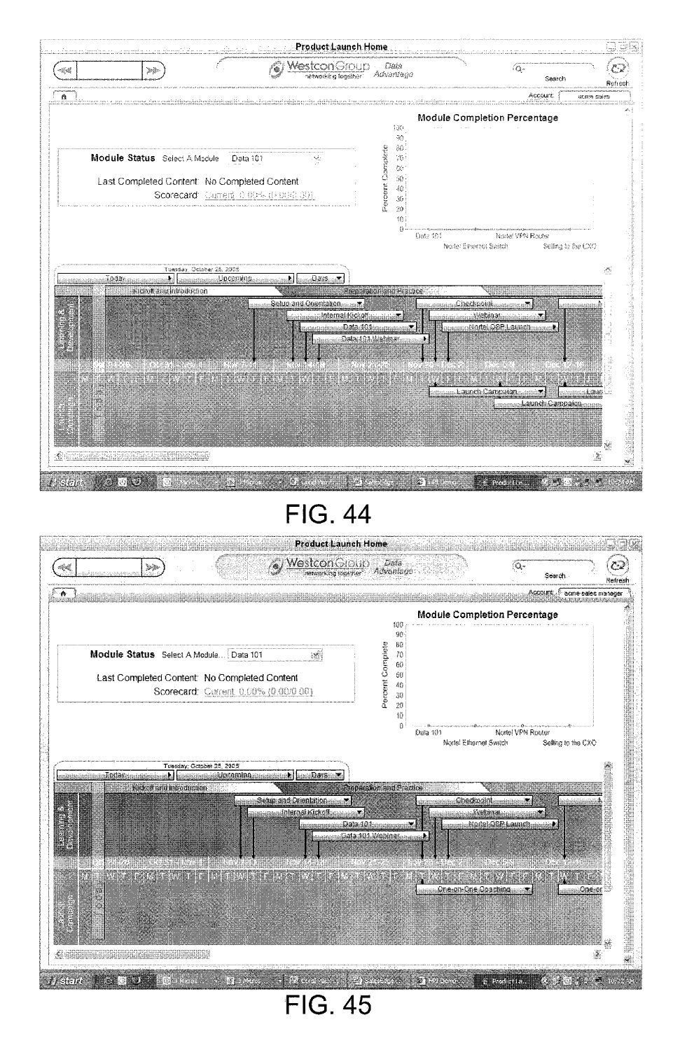

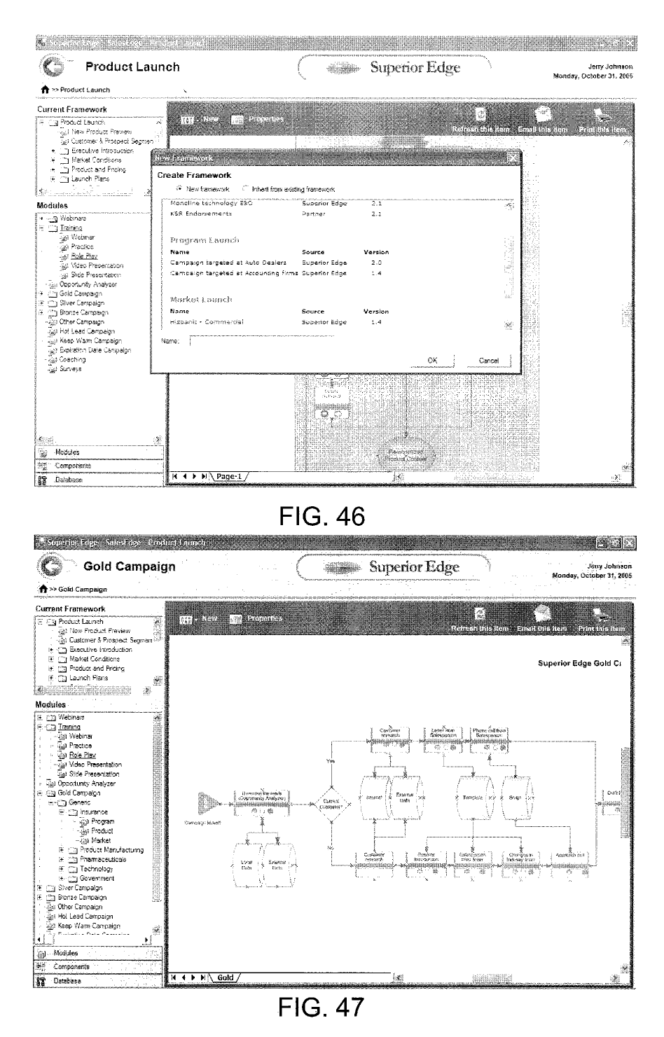

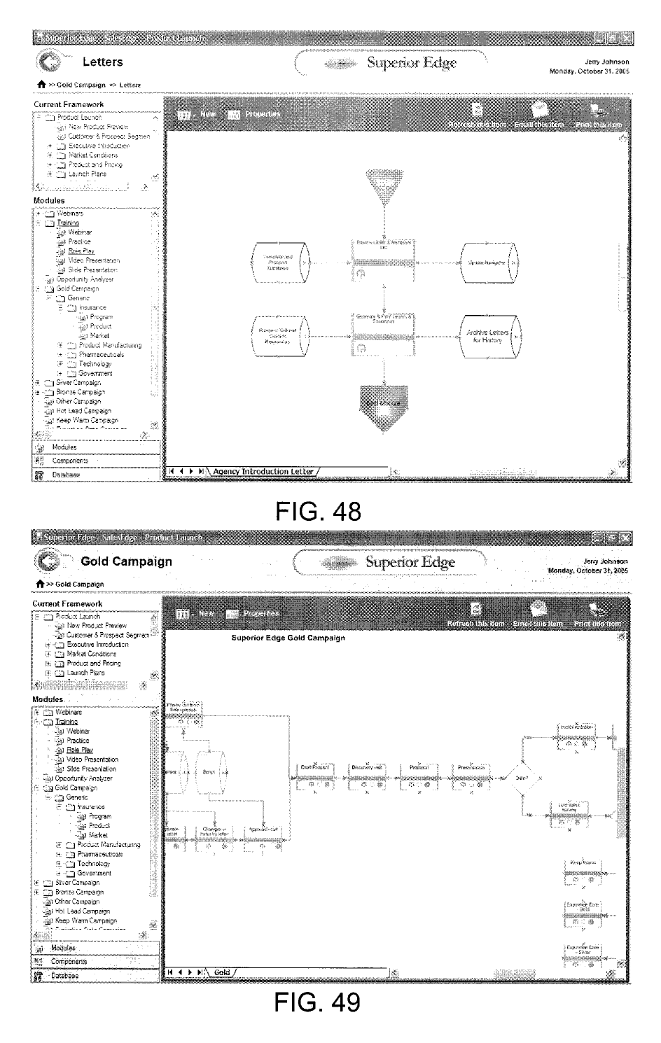

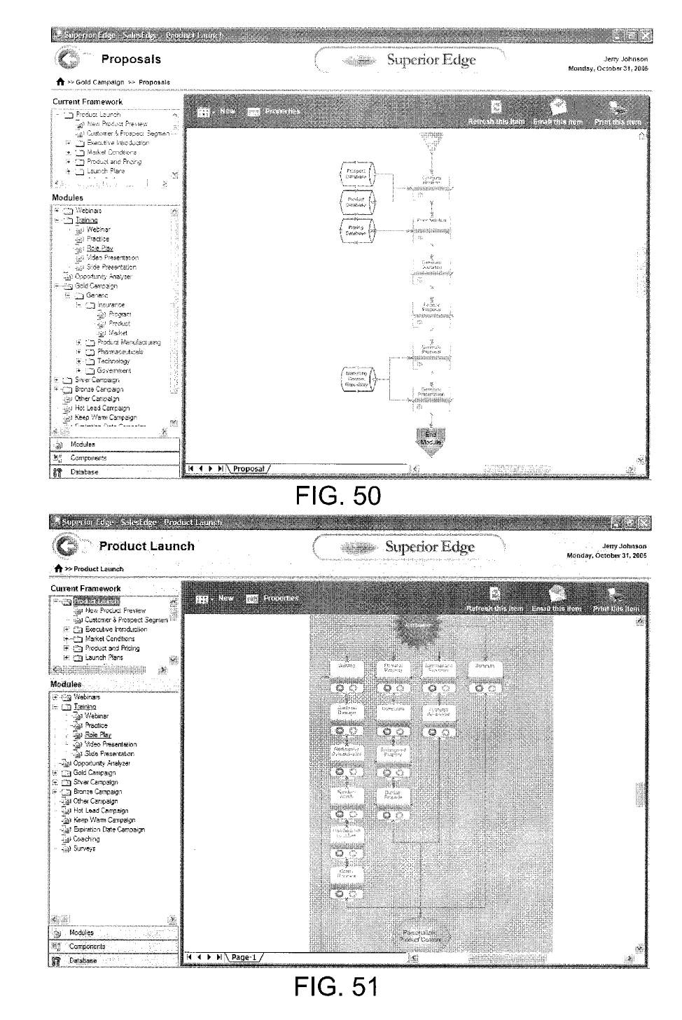

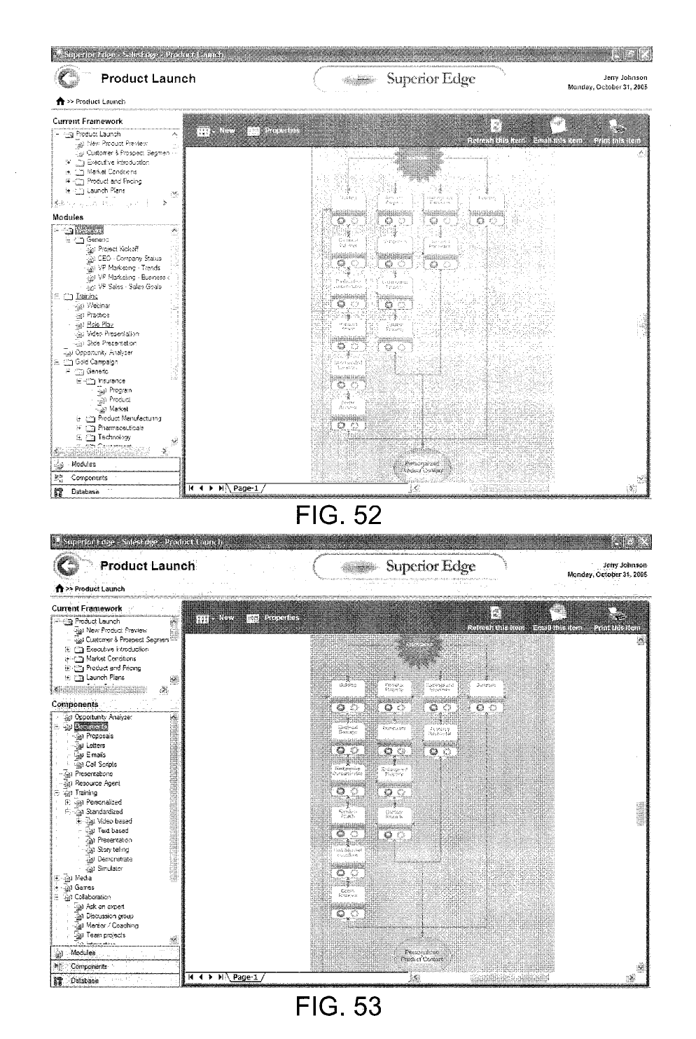

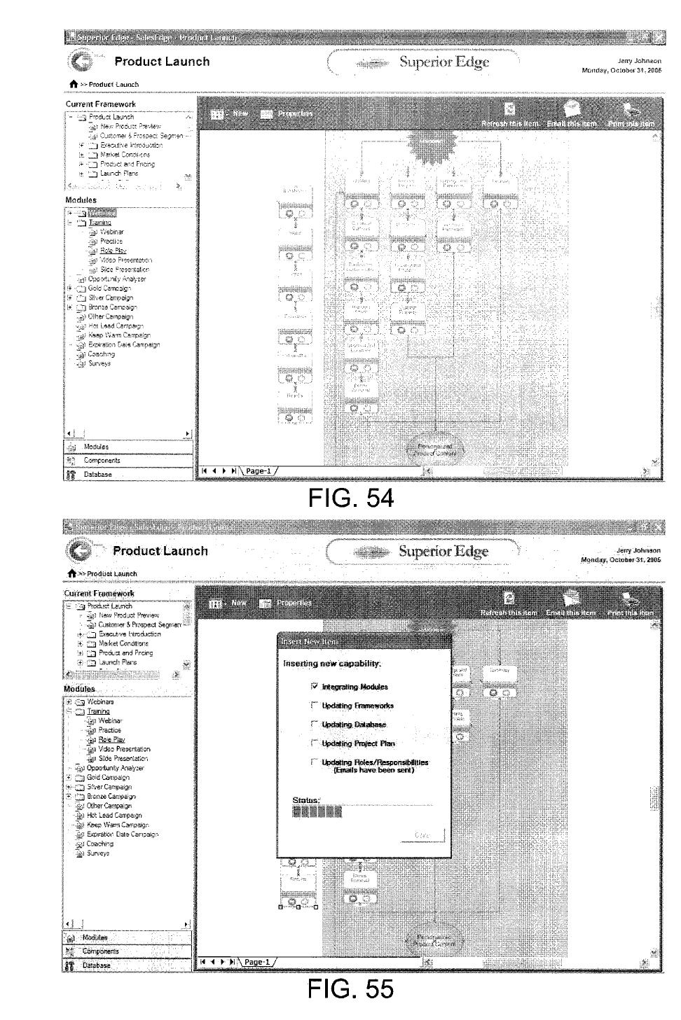

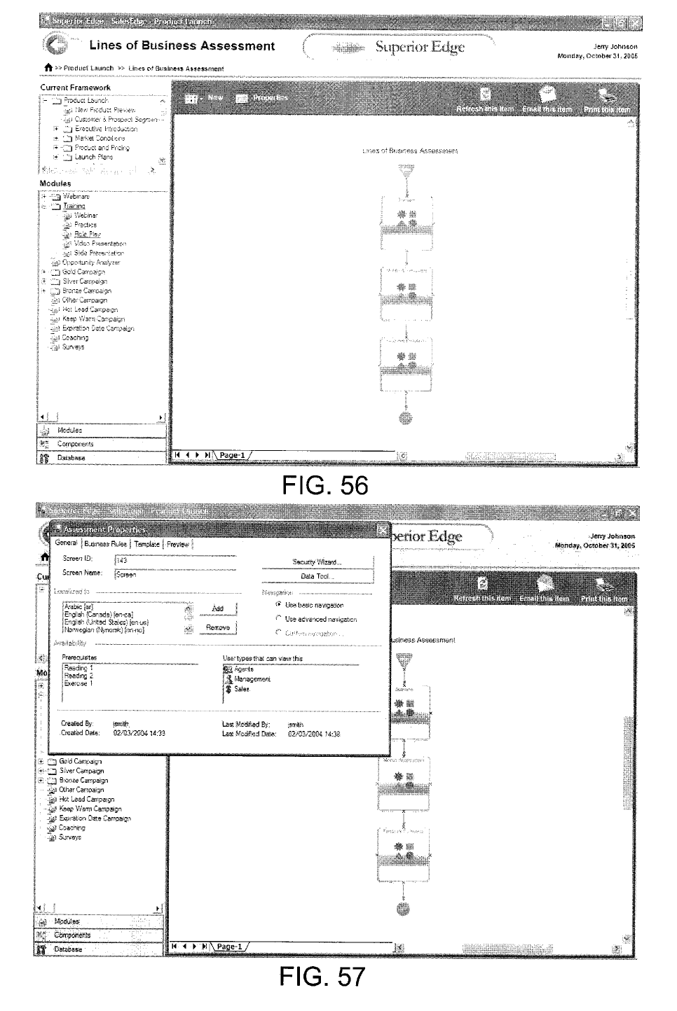

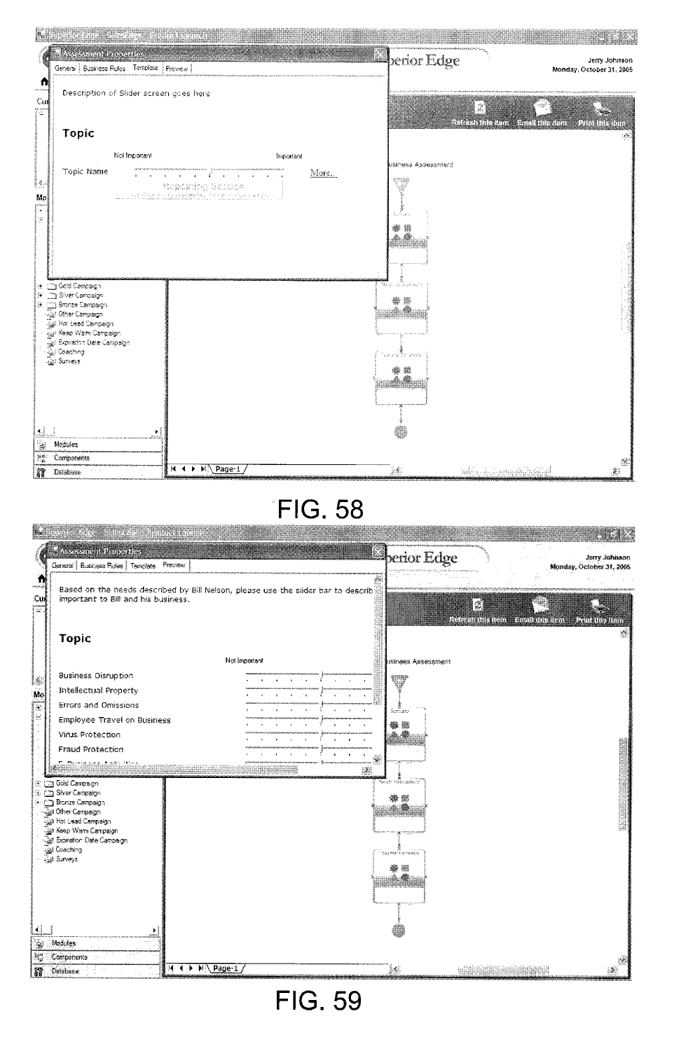

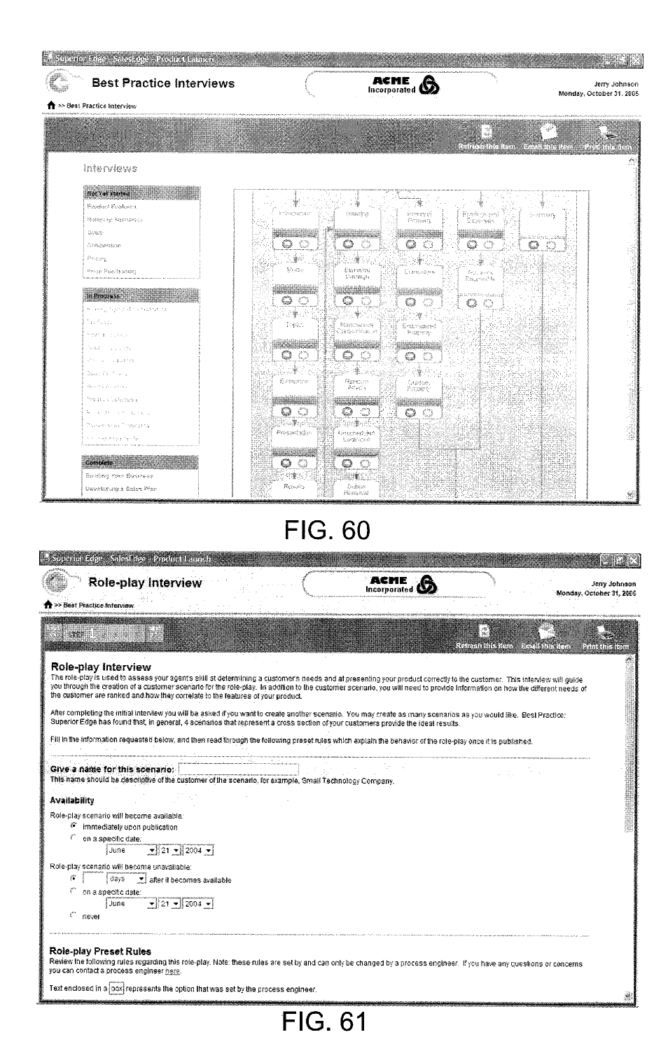

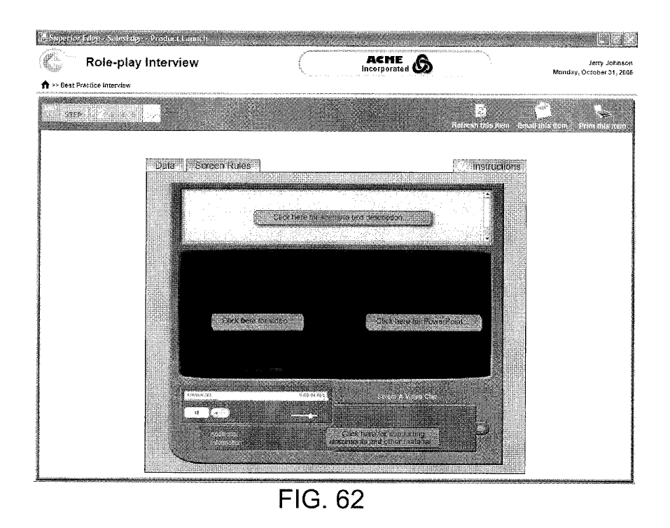

FIGS. 46 through 62 show how a series of frameworks made of common components can be created, modified and deleted. FIG. 47 shows that modules are made up of components and the components are organized in a visual way. FIG. 48 shows that some components can be further defined by drilling down on the initial screen for the components. FIG. 49 shows another example of a campaign. FIG. 50 shows another example of a drill down. FIG. 51 shows a training module made up of training components. FIG. 52 shows prebuilt modules can be used or reused in different frameworks. FIG. 53 shows prebuilt components can be used in modules and frameworks. FIG. 54 shows prebuilt modules can be “drag and dropped” to visually develop the frameworks. FIG. 55 shows making the integration of components and modules as easy as possible including databases. FIG. 56 shows another example of drilling down in a module, in this case an assessment to the components. FIG. 57 shows the components can be drilled down to review the user interface (UI) and to add the business rules. FIG. 58 shows an example of a UI drill down, without data and FIG. 59 with data. FIG. 60 shows a client needs to add data to the module, red items are required data. FIG. 61 shows the client needs to add the business rules to control the behavior of the module. FIG. 62 shows a drag and drop interface to add content to module templates.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the web interface such that different dialog boxes are presented to a user that are organized or designed differently while maintaining substantially the same functionality without departing from the scope and spirit of the present invention.

1. A process execution support system, comprising:
a software module for launching a campaign, the software module comprising components integrated from a variety of sources, including one or more of existing pre-designed components, existing client components, and third party components; and
a user delivery module configured to organize and deliver the components to a user based on a series of parameters including one or more of a role in an organization, knowledge of the user, skill level of the user, and how the user performs work.

2. The system of claim 1 wherein one or more components are selected for performing functions including one or more of data mining, sales, portals, e-commerce, e-learning, training, communications, product configuration, sales proposal, order entry, enterprise resource planning, customer segmentation, and interactive selling.

3. The system of claim 1 wherein the parameters comprise one or more of: the user defining the process, geography, regulations, experience and knowledge of the user, the user's role in the organization, type of sales prospect, and the type of contract scope of the user.

4. The system of claim 1 further comprising an analytics module configured to measure one or more of: user competency, user activities, lead generation, sales call effectiveness, and actual sales versus plan.

5. The system of claim 1 further comprising an analytics module configured to report sales trends or status through observation of activity in the system without requiring manual input from the user.

6. A computerized method of defining a campaign training module comprising:
collecting and maintaining user data defining a user profile including a role of each user;
defining and storing one or more tasks;
assigning and storing one or more user roles to each task;
designating and storing an order to which the tasks are to be completed;
defining and storing a campaign by assigning one or more of the tasks to the campaign; and
generating a campaign schedule by:
retrieving the one or more tasks assigned to the campaign;
identifying users affected by the campaign as a function of task role assignments and user profile roles;
ordering the tasks as a function of the designated order of tasks; and
notifying at least one user to perform a task of the campaign.

7. The method of claim 6, wherein a user profile includes information identifying one or more of a user skill set, user knowledge, and an association to a user scheduling calendar.

8. The method of claim 6, wherein a definition of one or more tasks includes a computer-based, multimedia presentation for a user to watch.

9. The method of claim 8, wherein the definitions of the one or more tasks further includes a question set for a user to answer, the user answers to which are indicative of understanding of the multimedia presentation by the user.

10. The method of claim 6, wherein a task includes one or more of contacting a sales prospect, coaching another person in an organization, completing a training session, and preparing and making a presentation.

11. The method of claim 6, wherein designating the order of which the tasks are to be completed includes identifying a relation of one or more of the tasks to one or more other tasks that affects when the one or more other tasks are to be performed.

12. A computer-readable medium, with encoded instructions to cause a suitably configured computer to:
collect and maintain user data defining a user profile including a role of each user;
define and store one or more tasks;
assign and store one or more user roles to each task;
designate and store an order to which the tasks are to be completed;
define and store a campaign by assigning one or more of the tasks to the campaign; and
generate a campaign schedule by:
retrieving the one or more tasks assigned to the campaign;
identifying users affected by the campaign as a function of task role assignments and user profile roles;
ordering the tasks as a function of the designated order of tasks; and
notifying at least one user to perform a task of the campaign.

13. The computer-readable medium of claim 12, wherein a user profile includes information identifying one or more of a user skill set, user knowledge, and an association to a user scheduling calendar.

14. The computer-readable medium of claim 12, wherein a definition of one or more tasks includes a computer-based, multimedia presentation for a user to watch.

15. The computer-readable medium of claim 14, wherein the definitions of the one or more tasks further include a question set for a user to answer, the user answers to which are indicative of understanding of the multimedia presentation by the user.

16. The computer-readable medium of claim 12, wherein a task includes one or more of contacting a sales prospect, coaching another person in an organization, completing a training session, and preparing and making a presentation.

17. The computer-readable medium of claim 12, wherein designating the order of which the tasks are to be completed includes identifying a relation of one or more of the tasks to one or more other tasks that affects when the one or more other tasks are to be performed.
